(19) United States
(12) Patent Application Publication
(10) Pub. No.: US 2025/0013249 A1
(43) Pub. Date: Jan. 9, 2025

(54) AUTONOMOUS FOLLOWER VEHICLE

(71) Applicant: Access Care Amenities Pty Ltd, Riverstone (AU)

(72) Inventor: Eamad John SABA, Kellyville Ridge, NSW (AU)

(21) Appl. No.: 18/765,644

(22) Filed: Jul. 8, 2024

(30) Foreign Application Priority Data
Jul. 7, 2023 (AU) 2023902191

(51) Int. Cl. G05D 1/686; B60W 10/20; G01C 21/00; G01C 21/16

(52) U.S. Cl. CPC G05D 1/686; B60W 10/20; G01C 21/1652; G01C 21/3837

(57) ABSTRACT

The present invention relates to an autonomous follower vehicle configured for following a guide element. The autonomous follower vehicle wirelessly determines the location of the guide element, maps the location of the guide element over time as a path, and controls a drive system on the autonomous vehicle to follow the same path traversed by the guide element, preferably using inertial navigation.

### CROSS-REFERENCE TO RELATED APPLICATION

This application claims priority of Australian Patent Application No. 2023902191 filed Jul. 7, 2023, the entire contents of which are hereby incorporated by reference in this application.

### FIELD

The present invention relates to an autonomous follower vehicle and in particular to an autonomous follower vehicle for following a pedestrian around an areas where obstacles may be present.

The invention has been developed primarily for use in/with pedestrians and will be described hereinafter with reference to this application. However, it will be appreciated that the invention is not limited to this particular field of use.

### BACKGROUND

At present autonomous follower vehicles are known in a wide variety of applications. Autonomous vehicles may follow a signal emitted by a homing beacon. Alternatively autonomous vehicles may physically embedded sensor trail that can be followed by the vehicle. In another alternative, all autonomous vehicle may follow a passenger while actively detecting obstacles while determining a path through the obstacles.

Any discussion of the background art throughout the specification should in no way be considered as an admission that such background art is prior art, nor that such background art is widely known or forms part of the common general knowledge in the field in Australia or any other country.

### SUMMARY

The invention seeks to provide an autonomous follower vehicle which will overcome or substantially ameliorate at least some of the deficiencies of the prior art, or to at least provide an alternative.

According to a first aspect, the present invention may be said to involve an autonomous follower vehicle (“AFV”) for following a guide element, the autonomous follower vehicle including:
a. a power source;
b. a prime mover;
c. a drive system configured for driving and steering the AFV;
d. a wireless locating system configured for locating the position of a guide element;
e. a control system configured for:
   i. wirelessly determining the location of the guide element using the wireless locating system;
   ii. mapping the determined location of the guide element; and
   iii. controlling the drive system to follow the same route traversed by the guide element.

According to a first aspect, the present invention may be said to involve an autonomous follower vehicle (“AFV”) for following a guide element, the autonomous follower vehicle including:
a. a power source;
b. a prime mover;
c. a drive system configured for driving and steering the AFV;
d. a wireless locating system configured for locating the position of a guide element;
e. a control system configured for:
   i. wirelessly determining the location of the guide element using the wireless locating system;
   ii. mapping the determined location of the guide element over time as a path; and
   iii. controlling the drive system to follow the same path traversed by the guide element.

The AFV as claimed in claim 1, wherein the controller is configured for:
a. controlling the drive system to follow the path traversed by the guide element using inertial navigation.

In one embodiment, the controller is configured for:
a. mapping the determined location of the guide element in absolute terms over time.

In one embodiment, the controller is configured for:
a. mapping the determined location of the guide element relative to the wireless locating system over time.

In one embodiment, the controller is configured for:
a. plotting the location of the guide element at an absolute geographic location.

In one embodiment, the controller is configured for:
a. plotting the location of the guide element at a location on an electronic map.

In one embodiment, the controller is configured for:
a. plotting the location of the guide element at an absolute geographic location on an electronic map, with reference to the AFV.

In one embodiment, the controller is configured for:
a. receiving a location signal from the wireless locating system.

In one embodiment, the controller is configured for:
a. determining the location of the guide element relative to the AFV.

In one embodiment, the controller is configured for:
a. wirelessly determining the location of the guide element at regular periodic intervals.

In one embodiment, the controller is configured for:
a. wirelessly determining the location of the guide element continuously.

In one embodiment, the controller is configured for:
a. determining the distance of the guide element from the AFV.

In one embodiment, the controller is configured for:
a. testing whether the location of the guide element is within a predetermined range of the AFV.

In one embodiment, the controller is configured for:
a. stopping movement of the AFV in the event that the location of the guide element is within a predetermined range of the AFV.

In one embodiment, the controller is configured for:
a. determining a path to be followed from the mapped location of the guide element.

In one embodiment, the controller is configured for:
a. allocating a path width to the determined path.

In one embodiment, the controller is configured for:
a. controlling the drive system to cause the AFV to follow the determined path.

In one embodiment, the controller is configured for:
a. controlling the drive system to cause the AFV to follow the determined path while staying within an allocated width.

In one embodiment, the controller is configured for:
a. receiving a sensor signals indicative of the speed and heading of the AFV.

In one embodiment, the controller is configured for:
a. determining the distance and heading that the AFV has travelled from the sensor signals.

In one embodiment, the controller is configured for:
a. mapping an updated location of AFV relative to the determined path of the guide element.

In one embodiment, the controller is configured for:
a. plotting the location of the AFV and an absolute geographic location on an electronic map.

In one embodiment, the controller is configured for:
a. plotting the location of the AFV and an absolute geographic location on an electronic map that moves with the AFV.

In one embodiment, the AFV includes a steering system.

In one embodiment, the steering system of the AFV includes a rack and pinion steering mechanism.

In one embodiment, the AFV includes a transmission.

In one embodiment, the transmission includes a track-type steering transmission.

In one embodiment, the wireless locating system includes one or more selected from:
a. a laser rangefinder;
b. radar rangefinder;
c. sonar rangefinder;
d. infrared rangefinder;
e. or any other suitable wireless range finding system for tracking the distance and/or direction of the guide element.

In one embodiment, the wireless locating system does not include an obstacle detection system.

In one embodiment, the wireless locating system includes one or more from the following sensors:
a. an accelerometer;
b. a compass; and
c. at least one or more wheel speed sensors.

In one embodiment, the controller is configured for:
a. determining movement of the AFV relative to the path followed by the guide element.

In one embodiment, the controller is configured for:
a. calculating the speed of the guide element; and
b. calculating the direction of movement of the guide element.

In one embodiment, the controller is configured for:
a. calculating the speed and direction of movement of the AFV.

In one embodiment, the controller is configured for:
a. comparing the calculated speed and/or direction of movement of the guide element to the calculated speed and direction of movement of the AFV.

In one embodiment, the controller is configured for:
a. controlling the drive system to match the speed of the guide element.

In one embodiment, the controller is configured for:
a. controlling the drive system to match the speed of the guide element when the AFV is not travelling in the same direction as the guide element.

In one embodiment, the AFV is configured for carrying a container.

In one embodiment, the container is a removable container.

In one embodiment, the AFV is configured for connection to at least one or more removable containers.

In one embodiment, the AFV includes connecting formations for connecting to at least one or more removable containers.

In one embodiment, the container is one or more selected from:
a. a golf bag:
b. a toolbox;
c. an insulated cooler box;
d. a fridge;
e. a freezer; and
f. any other container.

In one embodiment, the AFV includes an electrical connector for connecting to the removable containers.

In one embodiment, the AFV is configured for powering the removable container.

In one embodiment, the controller is configured for
a. cutting power to the removable container if the power in the power source reduces below a predetermined level.

In one embodiment, the prime mover is an internal combustion engine and fuel supply.

In one embodiment, the prime mover is an electric motor and an electrical power source.

In one embodiment, the power source is a battery.

In one embodiment, the power source is a fuel cell.

In one embodiment, the controller includes:
a. a processor, the processor being operably connected to
b. digital storage media, the digital storage media configured for storing digital instructions for directing the processor.

In one embodiment, the controller is configured for:
a. controlling the drive system to follow the same route traversed by the guide element in the absence of an external map.

In one embodiment, the controller is configured for:
a. controlling the drive system to follow the same route traversed by the guide element in the absence of a map of the area.

In one embodiment, the controller is configured for:
a. controlling the drive system to follow the same off-road route traversed by the guide element.

In one embodiment, the controller is configured for:
a. controlling the drive system to maintain a predetermined distance from the guide element while following the same route traversed by the guide.

In one embodiment, the controller is configured for:
a. controlling the drive system to maintain a predetermined distance from the guide element while the guide element is moving away from the autonomous follower vehicle.

In one embodiment, the controller is configured for:
a. controlling the drive system to keep the autonomous follower vehicle in the same position while the guide element is moving towards the autonomous follower vehicle.

According to a further aspect, the present invention may be said to involve a method of controlling an AFV, the AFV including a wireless locating system and a drive system, the method being carried out on an electronic device and including the steps of:
a. wirelessly determining the location of the guide element using a wireless locating system;
b. mapping the location of the guide element over time; and
c. controlling the drive system to follow the route traversed by the guide element.

According to a further aspect, the present invention may be said to involve a method of controlling an AFV, the AFV including a wireless locating system and a drive system, the method being carried out on an electronic device and including the steps of:
a. wirelessly determining the location of the guide element using the wireless locating system;
b. mapping the determined location of the guide element over time as a path; and
c. controlling the drive system to follow the same path traversed by the guide element.

In one embodiment, the method comprises the step of:
a. controlling the drive system to follow the path traversed by the guide element using inertial navigation.

In one embodiment, the method comprises the step of:
a. plotting the location of the guide element at an absolute geographic location.

In one embodiment, the method comprises the step of:
a. plotting the location of the guide element at an absolute geographic location on an electronic map.

In one embodiment, the method comprises the step of:
a. plotting the location of the guide element at an absolute geographic location on an electronic map, with reference to the AFV.

In one embodiment, the method comprises the step of:
a. receiving a location signal from the wireless locating system.

In one embodiment, the method comprises the step of:
a. determining the location of the guide element relative to the AFV.

In one embodiment, the method comprises the step of:
a. wirelessly determining the location of the guide element at regular periodic intervals.

In one embodiment, the method comprises the step of:
a. wirelessly determining the location of the guide element continuously.

In one embodiment, the method comprises the step of:
a. determining the distance of the guide element from the AFV.

In one embodiment, the method comprises the step of:
a. testing whether the location of the guide element is within a predetermined range of the AFV.

In one embodiment, the method comprises the step of:
a. stopping movement of the AFV in the event that the location of the guide element is within a predetermined range of the AFV.

In one embodiment, the method comprises the step of:
a. determining a path to be followed from the mapped location of the guide element.

In one embodiment, the method comprises the step of:
a. allocating a path width to the determined path.

In one embodiment, the method comprises the step of:
a. controlling the drive system to cause the AFV to follow the determined path.

In one embodiment, the method comprises the step of:
a. controlling the drive system to cause the AFV to follow the determined path while staying within an allocated width.

In one embodiment, the method comprises the step of:
a. receiving a sensor signals indicative of the speed and heading of the AFV.

In one embodiment, the method comprises the step of:
a. determining the distance and heading that the AFV has travelled from the sensor signals.

In one embodiment, the method comprises the step of:
a. mapping an updated location of AFV relative to the determined path of the guide element.

In one embodiment, the method comprises the step of:
a. wirelessly determining the location of the guide element at regular periodic intervals.

In one embodiment, the method comprises the step of:
a. wirelessly determining the location of the guide element continuously.

In one embodiment, the method comprises the step of:
a. plotting a path of the guide element relative to the AFV.

In one embodiment, the method comprises the step of:
a. plotting the location of the AFV at a location relative to the AFV.

In one embodiment, the method comprises the step of:
a. plotting the location of the AFV and an absolute geographic location on a map.

In one embodiment, the method comprises the step of:
a. determining the direction and speed of movement of the AFV.

In one embodiment, the method comprises the step of:
a. determining the movement of the AFV relative to the path followed by the guide element.

In one embodiment, the method comprises the step of:
a. calculating the speed of the guide element; and
b. calculating the direction of movement of the guide element.

In one embodiment, the method comprises the step of:
a. calculating the speed and direction of movement of the AFV.

In one embodiment, the method comprises the step of:
a. comparing the calculated speed and/or direction of movement of the guide element to the calculated speed and direction of movement of the AFV.

In one embodiment, the method comprises the step of:
a. controlling the drive system to match the speed of the guide element.

In one embodiment, the method comprises the step of:
a. controlling the drive system to match the speed of the guide element when the AFV is not travelling in the same direction as the guide element.

In one embodiment, the method comprises the step of:
a. cutting power to the removable container if the power in the power source reduces below a predetermined level.

According to a further aspect, the present invention may be said to involve a vehicle (“AFV”) for carrying a load, the vehicle including:
a. a power source;
b. a prime mover;
c. a drive system configured for driving and steering the AFV;
d. a chassis configured for being reconfigured between a
   i. deployed configuration in which the chassis is capable of carrying a load, and a
   ii. retracted configuration in which the chassis is reduced in size; and
e. a control system configured for controlling movement of the vehicle.

In one embodiment, the controller is configured for allowing remote control of the vehicle from a remote controller.

In one embodiment, the controller is configured for allowing wireless remote control of the vehicle from a remote controller.

In one embodiment, the vehicle includes a wireless locating system configured for determining one or more selected from the direction and distance of a guide element.

In one embodiment, the controller is configured for:
a. wirelessly determining the location of the guide element using the wireless locating system.

In one embodiment, the controller is configured for:
a. mapping the determined location of the guide element over time.

In one embodiment, the controller is configured for:
a. mapping the determined location of the guide element relative to the vehicle over time.

In one embodiment, the controller is configured for:
a. mapping the determined location of the guide element in absolute terms over time.

In one embodiment, the controller is configured for:
a. controlling the drive system to follow the same route traversed by the guide element.

In one embodiment the vehicle includes a set of wheels.

According to a further aspect, the present invention may be said to involve a chassis for a vehicle, the vehicle being configured for carrying a load, the chassis including:
a. a frame that is reconfigurable between
   i. a deployed configuration in which the chassis is capable of carrying a load, and a
   ii. retracted configuration in which the chassis is reduced in size.

In one embodiment, the frame includes a main body.

In one embodiment, the frame includes at least one or more reconfigurable portions.

In one embodiment, the reconfigurable portions are arms.

In one embodiment, the reconfigurable portions are connected to the main body by a reconfigurable connection.

In one embodiment, the reconfigurable connection is one or more selected from:
a. a pivoting connection;
b. a sliding connection;
c. an expanding connection;
d. or the like.

In one embodiment, the reconfigurable portions are configured for connection to wheels.

In one embodiment, the reconfigurable portions are configured for movement between a
a. retracted position in which the chassis is reduced in one or more selected from width and length; and a
b. deployed position in which the chassis is increased in one or more selected from width and length.

In one embodiment, the retracted position of the reconfigurable portions correspond to the folded configuration of the frame.

In one embodiment, the deployed position of the reconfigurable portions correspond to the deployed configuration of the frame.

In one embodiment, the foldable portions are configured for pivotable connection to the main body.

In one embodiment, the foldable portions are configured for pivotable connection to the main body about a vertical axis.

In one embodiment, the foldable portions are foldable arms.

In one embodiment, the foldable portions include a distal end and a proximal end.

In one embodiment, the foldable portions are configured for pivotable connection to the main body about a horizontal axis.

In one embodiment, the foldable portions house a transmission.

In one embodiment, the foldable portions house an electrical connection.

In one embodiment, the transmission includes planetary gear.

In one embodiment, the transmission includes at least one or more constant velocity joints.

In one embodiment, the foldable portions include an electric motor configured for driving a drive wheel at the distal end.

In one embodiment, the foldable portions include an electric motor configured for steering a steering wheel at the distal end.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a top left front perspective assembly view of a first embodiment of an AFV with a removable cooler box;

FIG. 2a shows a top left front perspective view of the AFV of FIG. 1 with a cooler box; and

FIG. 2b shows a top left front perspective view of the AFV of FIG. 1 with a removable toolbox;

FIG. 3 shows a top left front perspective view of the AFV of FIG. 1 with a pair of golf bags;

FIG. 4 shows a top left front perspective view of the AFV of FIG. 1 with the removable container removed;

FIG. 5 show a schematic diagram of a steering system:

FIG. 6 shows a schematic diagram of a drive system;

FIG. 7 shows a schematic view of an AFV following a guide element associated with a person;

FIG. 8 shows a schematic view of an AFV following the determined path of a guide element;

FIG. 9 shows a schematic diagram illustrating a controller connected to a wireless locating system;

FIG. 10 shows a flow chart illustrating the methodology followed by the controller;

FIG. 11a shows a schematic top view of a second embodiment of an AFV in a deployed configuration;

FIG. 11b shows a schematic top view of a the AFV of FIG. 11a in a retracted configuration;

FIG. 12 shows an AFV connected to computing devices over the Internet;

FIG. 13 shows a top rear left side perspective view of a third embodiment of an AFV with a cooler bin attached.

FIG. 14 shows a top rear left side perspective view of the AFV of FIG. 13 with the cooler box removed;

FIG. 15 shows a top view of how an AFV maps the location of the guide element at regular intervals;

FIG. 16 shows a top view of how an AFV determines a path to be followed by the AFV from the mapped location of the guide element of FIG. 15; and

FIG. 17 shows how the AFV controls the AFV to follow the mapped route of the guide element.

### DESCRIPTION OF EMBODIMENTS

It should be noted in the following description that like or the same reference numerals in different embodiments denote the same or similar features.

### Autonomous Follower Vehicle (AFV)

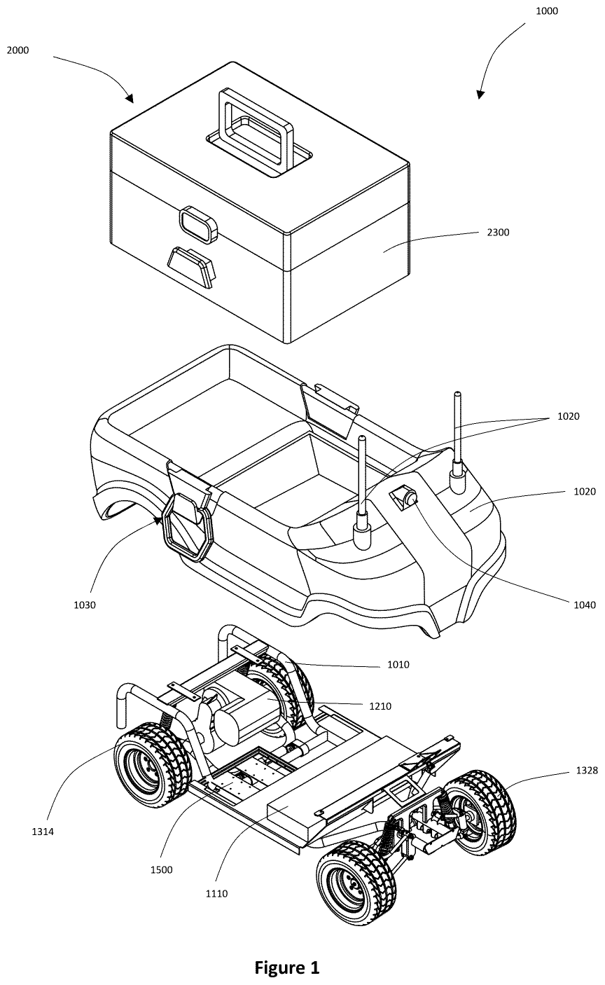

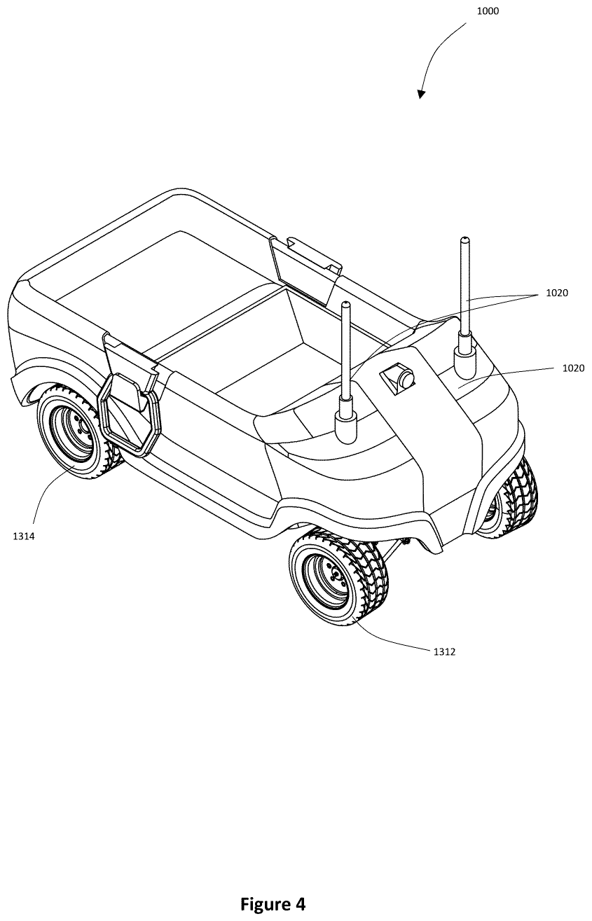

According to a first aspect, and as shown in FIGS. 1-4, an autonomous follower vehicle (“AFV”) 1000 is provided for following a guide element. The AFV includes a power source 1100, a prime mover 1200, a drive system 1300 a wireless locating system 1400 and a controller 1500.

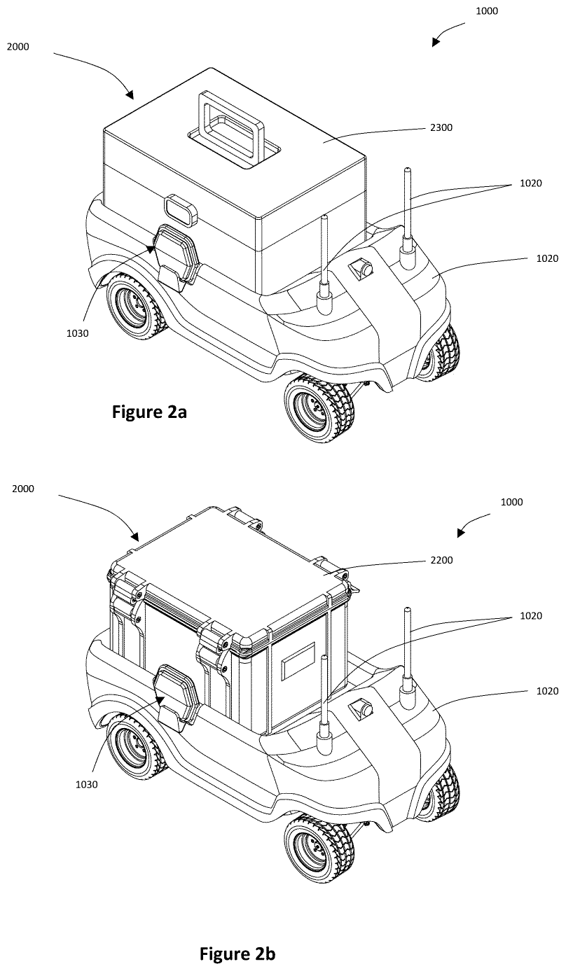

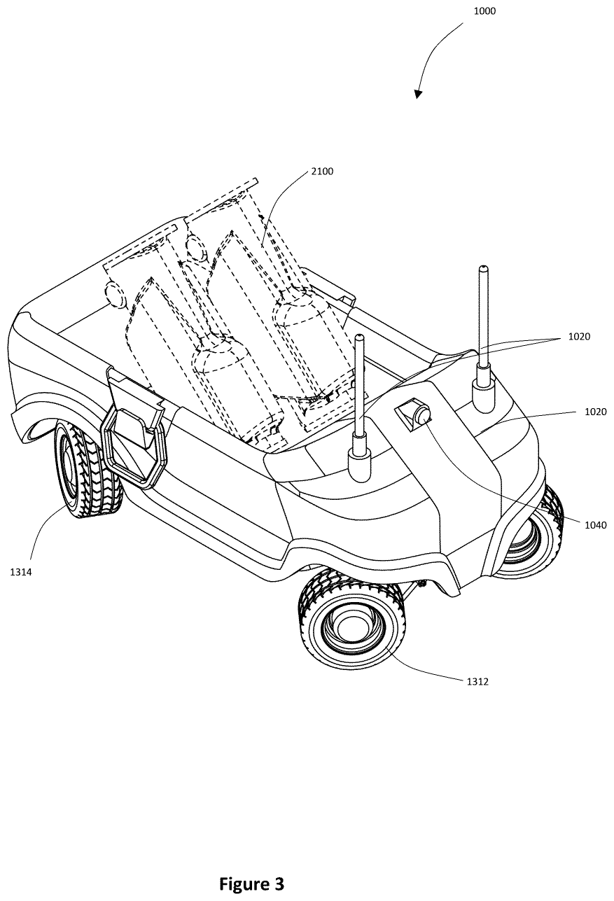

The AFV 1000 is preferably configured for carrying a preferably removable container 2000. The AFV preferably includes a support frame 1010 and a body 1020. On a supporting frame or body 1020. The container 2000 may be one or more golf bags 2100 (shown in FIG. 3), toolboxes 2200 (shown in FIGS. 1 and 2b), insulated cooler boxes 2300 (shown in FIG. 2a), fridges, freezers or the like. The AFV is preferably provided with connecting formations 1030 for connecting to the container. The connector formations can include electrical connectors (not shown) for connecting to the container electrically. Such electrical connectors are known in the art and a discussion of these is considered beyond the scope of this specification. It is envisaged that the power source 1100 of the AFV may be able to power the container (for example a fridge or freezer) through the electrical connector. The controller 1500 may be configured to ensure that the power level of the power source 1100 is never depleted beyond a predetermined level.

The power source 1100 could be a battery 1110, a fuel cell, or a fuel storage container, depending on the nature of the prime mover 1200. These are preferably mounted on the frame 1010. The prime mover 1200 is for driving the AFV 1000 via the drive system 1300. The prime mover 1200 could be an internal combustion engine (not shown) or an electric motor 1210.

The drive system 1300 is preferably also mounted on the frame 1010, and is configured for driving and steering the AFV. The drive system 1300 preferably includes a transmission 1310 and a steering system 1320. The transmission 1310 preferably includes some sort of a gearbox 1312 and drive wheels 1314. It is envisaged that the drive wheels 1314 may contact the ground directly to drive the AFV 1000, or that the drive wheels 1314 may drive a track system (not shown). In embodiment shown in FIG. 3, the drive wheels 1314 are also capable of being steered.

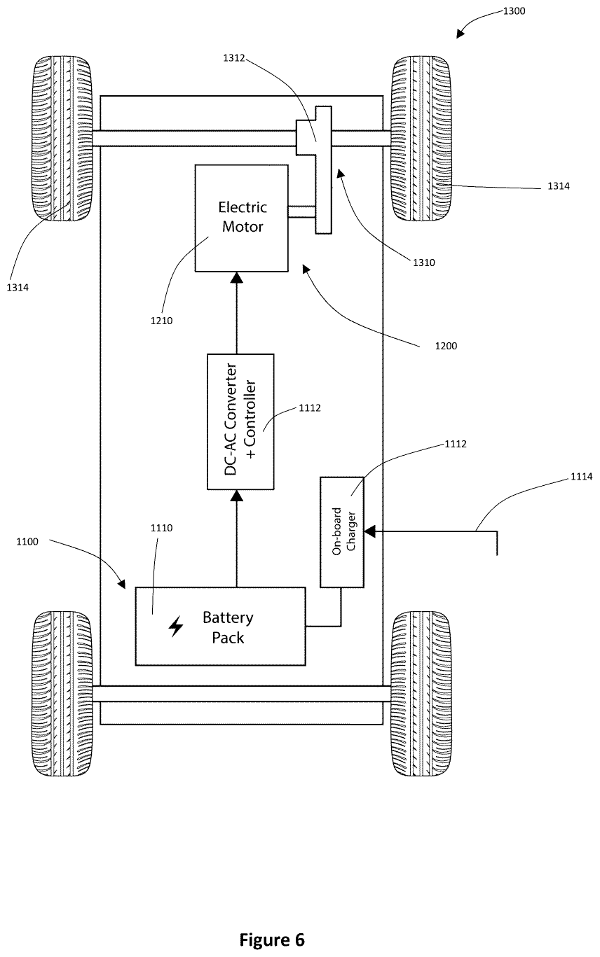

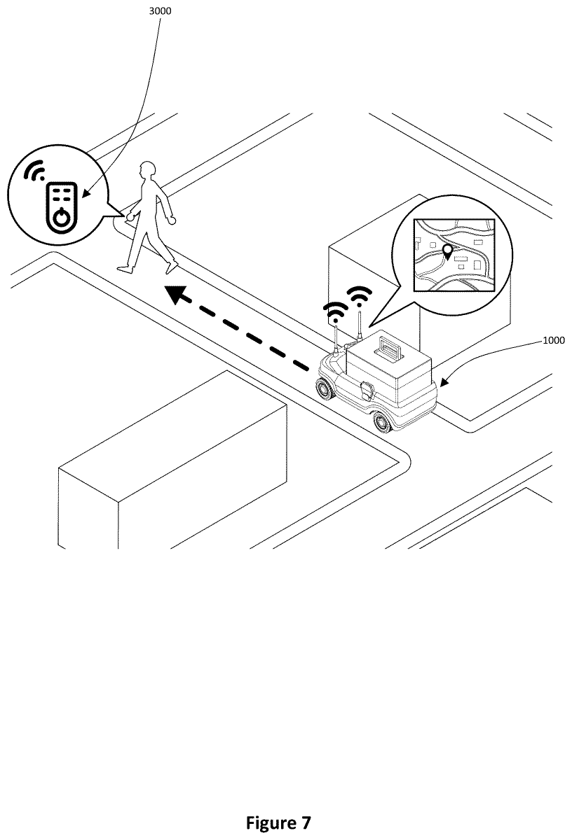

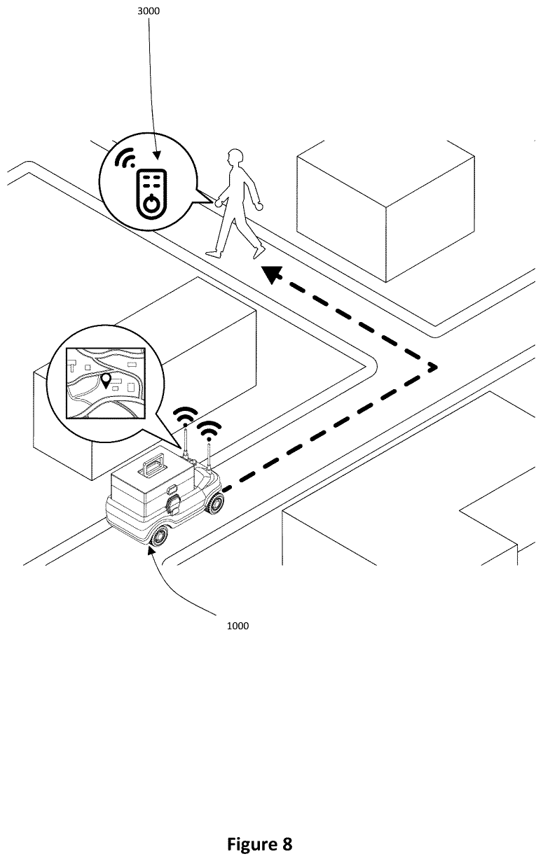

One example of a drive system 1300 is shown in FIG. 6. In the example shown, a battery pack 1110 drives an electric motor 1210 via a DC to AC converter 1112. Drive from the electric motor 1210 is transferred to drive wheels 1320 through a single ratio transmission 1310. A charging controller 1112 is provided for controlling charging from mains power via a charging connector 1114.

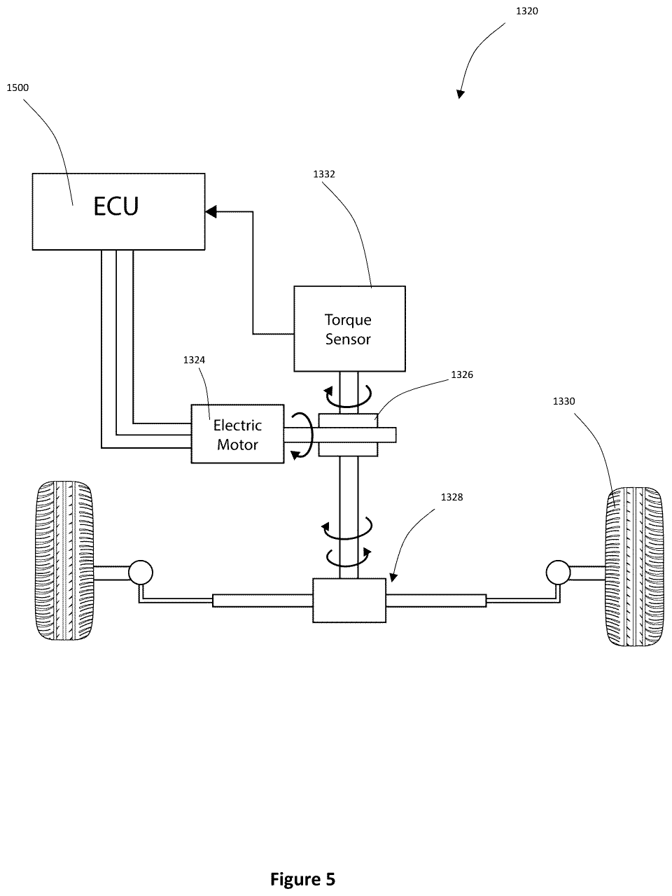

One embodiment of a steering system 1320 is shown in FIG. 5. In this embodiment, the controller 1500 is connected to an steering electric motor 1210 to control operation of the steering electric motor 1324. The steering electric motor 1324 is connected to an assist gear 1326 which in turn drives a rack and pinion gear set 1328 to turn steering wheels 1330 of the AFV 1000. A torque sensor 1332 provides feedback to the controller.

In an alternative embodiment (not shown), it is envisaged that the controller 1500 could control one or more drive wheels 1320 associated with tracks on opposed sides of the vehicle to thereby also steer the AFV 1000, as is known in tracked vehicles. Providing a tract transmission and steering system would be advantageous in that it allows for very small turning circles and part control of the direction and heading of the AFV 1000 as will be seen in more detail below

The wireless locating system 1400 is configured for locating the position of a guide element 3000. The wireless locating system can include one or more selected from a laser rangefinder; radar rangefinder; sonar rangefinder; infrared rangefinder; or any other suitable wireless range finding system for tracking the distance and/or direction of the guide element 3000. Electromagnetic type rangefinders shown in the figures that operate via a pair of antennas 1418 located on opposed sides of the AFV 1000.

It is envisaged that the wireless locating system 1400 will include a pair of sensors that will allow for the triangulation of the guide element 3000 to determine the direction and distance of the guide element 3000 relative to the wireless locating system 1400.

The guide element 3000 can be a visually recognizable element, a reflector, a passive transmitter that responds passively to a signal sent out from the wireless locating system, or an active transmitter that transmits wireless signals that can be received by the wireless locating system 1400.

It is envisaged that the wireless locating system will preferably not include an obstacle detection system, as this will add a level of complexity that would be cost prohibitive for the context of use of the present autonomous vehicle. However, such an obstacle detection system may be provided that allows the presence of obstacles to be detected and mapped. A discussion of the mapping will be provided in more detail below.

The wireless locating system 1400 preferably also preferably includes one or more accelerometers 1412; an electronic compass 1416; and at least one or more wheel speed sensors 1414 for use in odometry. The accelerometer 1412 is used for measuring the acceleration of the AFV 1000 in preferably three perpendicular planes. The accelerometer can be used to determine changes in direction of the AFV, as well as for determining the speeds to which the AFV has accelerated to, by measuring the time over which the AFV has accelerated. The compass 1416 can be used to determine the heading or direction of travel of the AFV 1000. The wheel speed sensors 1414 can be used to determine the speed of the vehicle by tracking the number of revolutions per minute that the wheels are turning, and by calculating the time that the vehicle has travelled at a certain speed, the distance that the AFV has travelled can be determined. It is envisaged that additional sensors 1418 may be provided, for example wheel slip sensors, and the like.

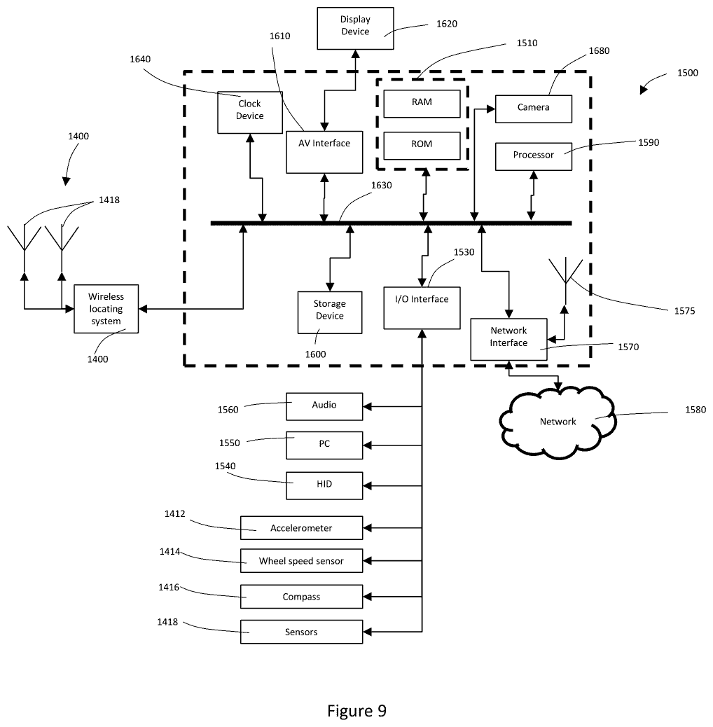

FIG. 9 shows a schematic diagram of a controller 1500. The methodology followed by the AFV, as described in further detail below, can be implemented as computer program code instructions executable by the controller 1500.

The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The controller 1500 preferably comprises semiconductor memory 1510 comprising volatile memory such as random access memory (RAM) or read only memory (ROM). The memory 1510 may comprise either RAM or ROM or a combination of RAM and ROM.

The controller 1500 further comprises I/O interface 1530 for communicating with one or more peripheral devices. The I/O interface 1530 may offer both serial and parallel interface connectivity. For example, the I/O interface 1530 may comprise a Small Computer System Interface (SCSI), Universal Serial Bus (USB) or similar I/O interface for interfacing with external devices such as the accelerometer 1412, wheel speed sensor 1414, compass 1416 and other sensors 1418. The I/O interface 1530 may also communicate with one or more human input devices (HID) 1540 such as keyboards, pointing devices, joysticks and the like.

The I/O interface 1530 may also comprise a computer to computer interface, such as a Recommended Standard 232 (RS-232) interface, for interfacing the controller 1500 with one or more personal computer (PC) devices 1550. The I/O interface 1530 may also comprise an audio interface 1560 for communicate audio signals to one or more audio devices (not shown), such as a speaker or a buzzer.

The controller 1500 also comprises a network interface 1570 for communicating with one or more computer networks 1580, such as the Internet. The network 1580 may be a wired network, such as a wired Ethernet™ network or a wireless network, such as a Bluetooth™ network, IEEE 802.11 network or cellular network. The network 1580 may be a local area network (LAN), such as a home or office computer network, or a wide area network (WAN), such as the Internet or private WAN. The controller 1500 can also include one or more antennas 1575 configured for wireless communication with network 1580.

The device 500 comprises an arithmetic logic unit or processor 1590 for performing the computer program code instructions. The processor 1590 may be a reduced instruction set computer (RISC) or complex instruction set computer (CISC) processor or the like. The controller 1500 further comprises a storage device 1600, such as a magnetic disk hard drive or a solid state disk drive for storing data and/or software instructions.

Computer program code instructions may be loaded into the storage device 1600 from the network 1580 using network interface 1570.

During the bootstrap phase, an operating system and one or more software applications are loaded from the storage device 1600 into the memory 1510. During the fetch-decode-execute cycle, the processor 1590 fetches computer program code instructions from memory 1510, decodes the instructions into machine code, executes the instructions and stores one or more intermediate results in memory 1510.

In this manner, the instructions stored in the memory 1510, when retrieved and executed by the processor 1590, configures the controller 1500 as a special-purpose machine that may perform the functions described herein.

The controller 1500 can also include an audio/video interface 1610 for conveying video signals to a display device 1620, such as a liquid crystal display (LCD), light emitting diode (LED) display, organic light emitting diode (OLED) display, cathode-ray tube (CRT) or similar display device.

The controller 1500 preferably includes a communication bus subsystem 1630 for interconnecting the various devices described above. The bus subsystem 1630 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like. The controller 1500 can also include a clock device 1640 configured for providing accurate time stamps for use by the processor 1590.

Preferably the controller 1500 that is operable by a user of the autonomous follower vehicle will be configured to be operatively connected to the wireless locating system 1400 in a manner as described below.

Lastly, it is anticipated that the controller 1500 can include a camera 1680. The camera 1680 can be used by the controller to detect and recognise visual images around the AFV 1000. To this end the camera may be configured to be movable to a variety of viewing angles, for example by being located on a movable gimbal (not shown). The camera 680 may be connected via the I/O interface 530 or may be built into the computing device.

It is further anticipated that the controller can be configured for controlling movement of the vehicle though a remote controller, for example via an app that is downloaded onto a mobile phone, and which is configured to make a preferably wireless connection to the vehicle, for example using the wireless communication technologies available on modern mobile phones such as a Bluetooth™ or WiFi™ thereby allowing a user to control movement of the vehicle by inputting control inputs on the mobile phone. Such technology is known and a discussion on the control methodology is considered beyond the scope of the present specification. In an alternative embodiment, a bespoke wireless or wired controller (not shown) may be provided as is known in the art for remote controlled vehicles.

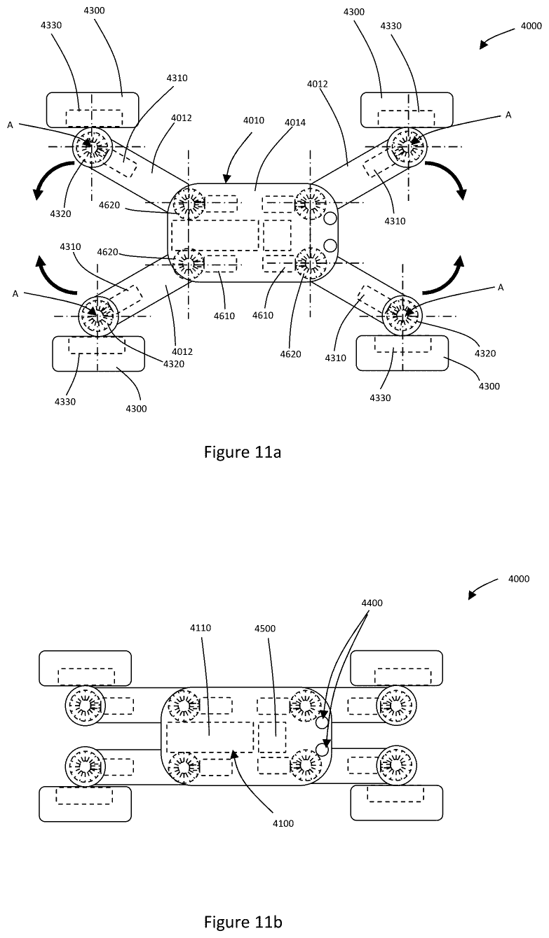

In a further embodiment, and as shown in FIGS. 11a and 11b, another embodiment of a vehicle 4000 is provided with a frame or chassis 4010 that is configured for being reconfigured between a deployed configuration in which the chassis is capable of carrying a load (as shown in FIG. 11a), and a retracted configuration in which the chassis is reduced in size (as shown in FIG. 11b).

The chassis 4010 includes four reconfigurable portions in the form of arms 4012. The arms 4012 are preferably pivotably connected to a central body 4014 at their proximal ends. The arms 4012 are also pivotably connected to steerable drive wheels 4300 at their distal ends.

The arms 4012 are movable about a reconfigurable connection 4600 in the form of a pivoting axle (not shown) that pivots about a substantially vertical pivot axis (shown in FIG. 11a as arrows A). The arms 4012 are movable between a retracted position in which the chassis is reduced in one or more selected from width and length (as shown in FIG. 11b); and a deployed position in which the chassis is increased in one or more selected from width and length (as shown in FIG. 11a). Preferably the retracted position of the arms corresponds to the retracted configuration of the chassis, and the deployed position of the arms corresponds to the deployed configuration of the chassis.

A reconfiguring electrical motor 4610 is provided for each arm, that acts through a transmission 4620 in the form of a circular rack and pinion gear set to cause the arms 4012 to pivot relative to the central body 4014 between their retracted position and their deployed position.

The steerable drive wheels 4300 are preferably steerable by steering electrical motors 4310 driving through a transmission 4320 such as a circular rack and pinion set. The steerable drive wheels 4310 are drivable by driving electrical motors 4330 located in the wheel hubs and acting directly on the wheels 4310.

In alternative embodiments (not shown) it is envisaged that the reconfigurable portions may be connected to the frame, chassis or central body using other reconfigurable connections, for example by sliding connections, rotating connections, expanding connections or the like.

The steering electrical motors 4310 and drive electrical motors 4330 are preferably electrically connected by wires extending through arms 4012 to a controller 4500 and a power source 4100 in the form of a battery 4110 located in the central body 4014.

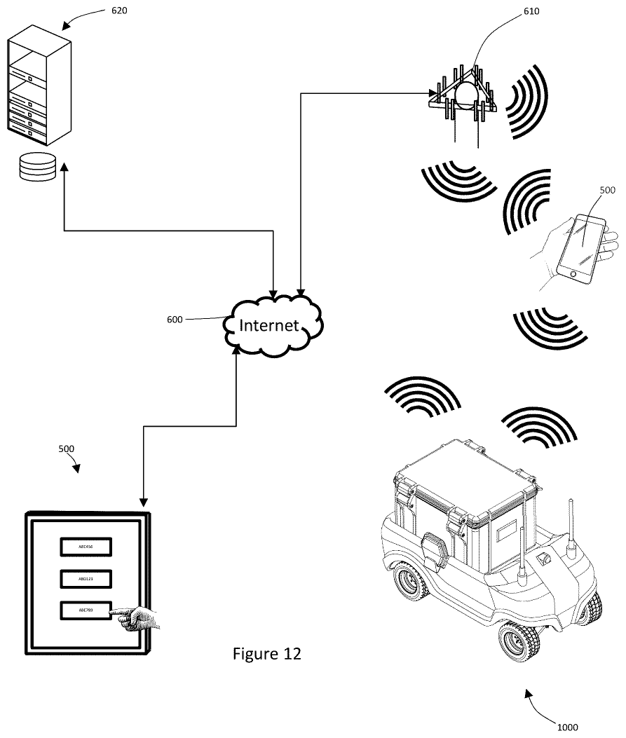

The controller is preferably similar to the controller discussed with reference to FIG. 9. The controller 4500 may be configured for controlling movement of the vehicle 4000 autonomously as will be described in more detail below, or through user inputs into a remote controller to cause the controller to steer and/or drive the vehicle. As shown in FIG. 12, the remote controller may be an application on a preferably mobile computing device such as a mobile phone 500, laptop, tablet, or the like that may be wirelessly connected directly to the vehicle 400, for example using WiFi or Bluetooth. Alternately the application may operate through a through a wide area network (WAN) 600 such as the Internet through cellular towers 610. The application may operate though back end servers 620 connected to the Internet. Alternatively the controller may be a dedicated remote controller which may be wired or wireless.

The controller 4500 acting through the steerable drive wheels 4300 acts as a drive system of the vehicle 4000.

The controller 4500 is also preferably configured to control movement of the arms 4012 from their retracted position to their deployed position on startup, and similarly to control movement of the arms 4012 from their deployed position to their retracted position on shutdown. Alternatively, it is envisaged that the chassis and/or arms can be manually reconfigurable.

The vehicle 4000 can also include a wireless locating system as described above.

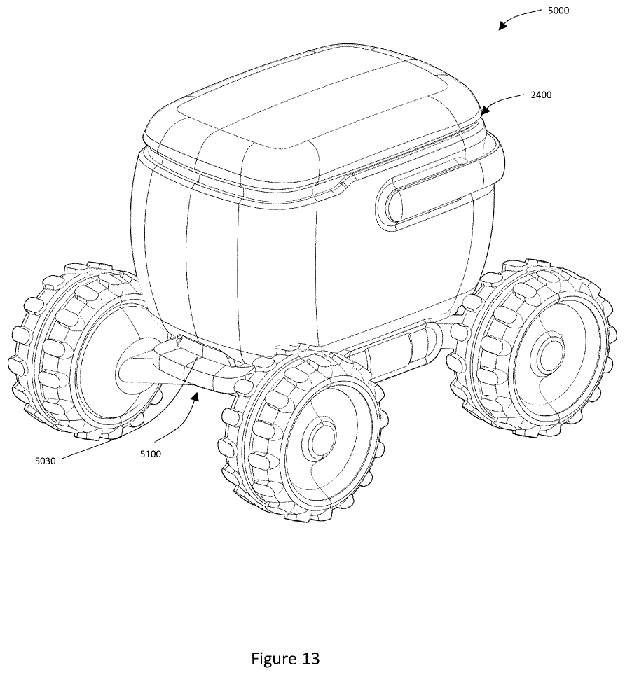

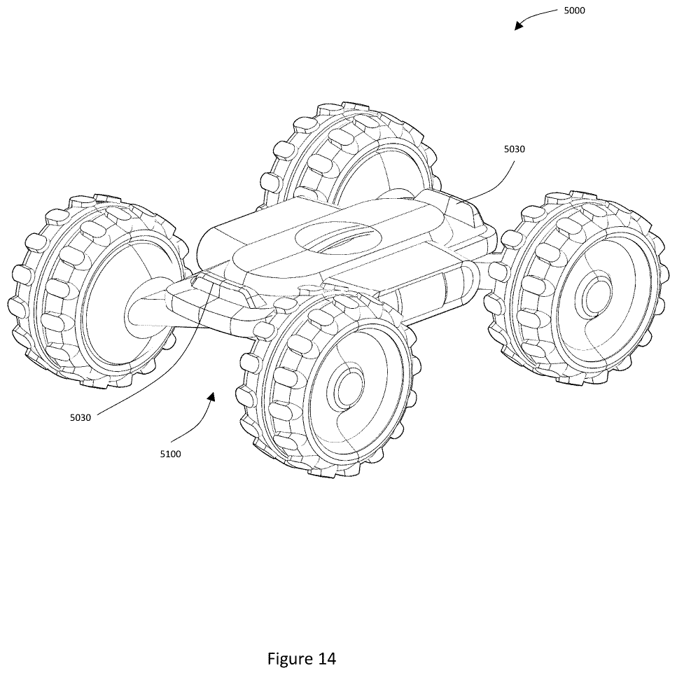

A further embodiment of an AFV 5000 is shown in FIGS. 13 and 14. In this embodiment, a removable insulated cooler box 2400 is removably connectable to the chassis 5100 by connecting formations 5030.

### Functionality

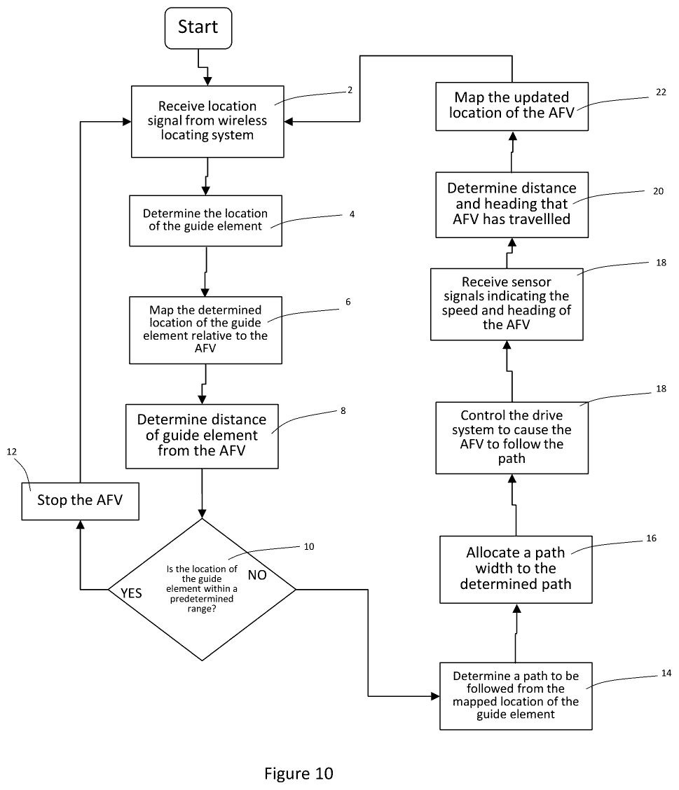

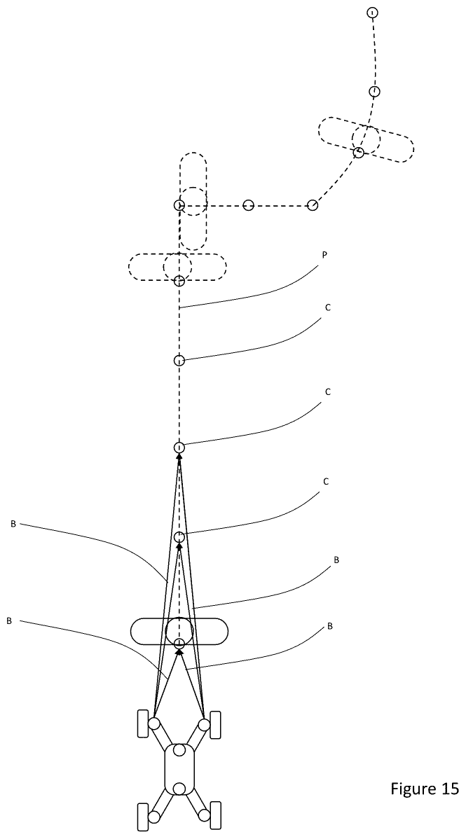

The functionality of the various embodiments described above will now be explained with reference to the flowchart shown in FIG. 10, and FIGS. 15-17.

The controller is configured for receiving 2 a location signal from the wireless locating system 1400 at regular periodic intervals. In an alternative embodiment, it is envisaged that the controller may receive the location signal continuously. As mentioned previously, the wireless sensors of the wireless locating system may be a laser rangefinder; radar rangefinder; sonar rangefinder; infrared rangefinder; or any other suitable wireless range finding system for tracking the distance and/or direction of the guide element. Preferably the sensors are configured for triangulating the location (heading and distance) of the guide element form a pair of wireless sensors as shown in FIG. 15 as arrows B.

The controller will then utilise the location signal to determine 4 the location of the guide element 3000 relative to the AFV 1000 as it follows a path (shown as the broken line P in FIG. 15). Once the location of the guide element 3000 is determined 4, the controller will map 6 the determined location of the guide element 3000 at regular periodic intervals. The mapped locations are shown in FIG. 15 as small circles C. In an in an alternative embodiment, it is envisaged that the determined location may be mapped 6 continuously.

Preferably when the controller 1500 is mapping 6 the determined location of the guide element, it will map an absolute geographic location to the guide element 3000 at that particular point in time, using the distance and heading of the guide element relative to the AFV. The location could be mapped, for example on an electronic map of the surrounding area, or even in the absence of an external map or known map of the surrounding area. For example the path being traversed may be offroad on a construction site or on a beach, where maps are not available for the area. At the same time, the determined location will be mapped 6 with reference to the AFV at that point in time. The path of the guide element will be logged by determining the locations of the guide element distance and heading measurements of the guide element relative to the AFV over time as the guide element moves, and then recording these locations as absolute positions on an internal map on the AFV. These absolute positions together make up a path or route.

In addition, the controller will determine 8 the distance of the guide element 3000 from the AFV 100, either as the distance along the mapped path or just the general distance in any direction. The controller 1500 will then test 10 whether the location of the guide element 3000 is within a predetermined range of the AFV 1000. If the guide element 3000 is within a predetermined range, then the controller 1500 will cause the AFV to stop moving. It is further envisaged that the controller 1500 will test whether the guide element 3000 is moving towards the AFV, and is within the predetermined range. If this is the case, then it is envisaged that the controller will not cause the AFV to move away from the guide element 3000, and instead will cause the AFV to remain still. In this way, the holder of the guide element 3000 can approach the AFP in order to interact with it and/or remove items such as tools and/or food stuff from the container. However, if the user with the guide element 3000 starts moving away from the AFV again, the controller will cause the AFV to start following the guide element 3000 at the predetermined distance again.

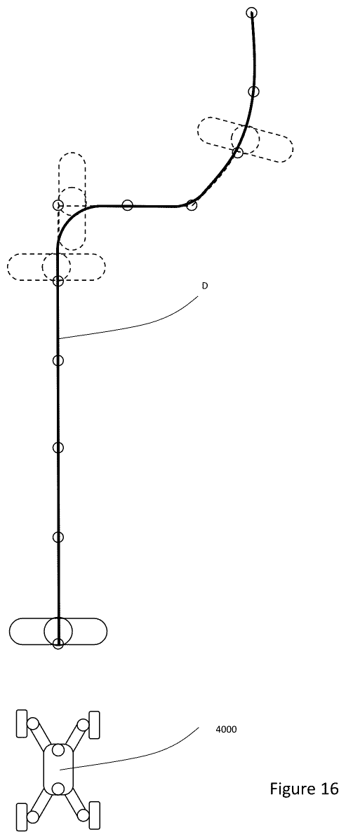

If the guide element 3000 is not within a predetermined range, then the controller 1500 will preferably determine 14 a path to be followed from the mapped locations of the guide element 3000. This is shown as solid line D in FIG. 16.

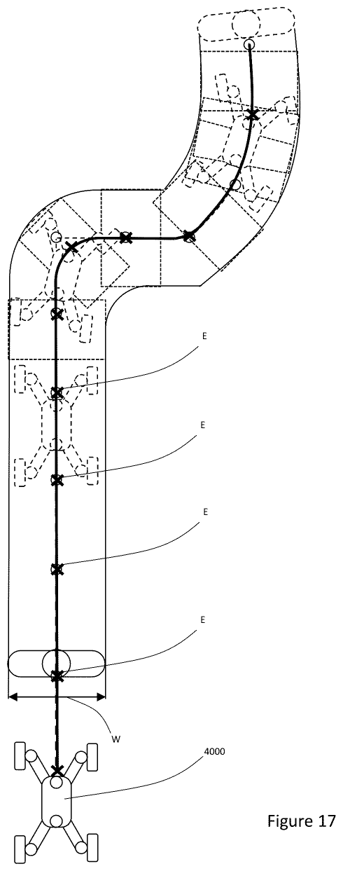

The controller 1500 will then control 16 the drive system to cause the AFV 1000, or a predetermined point on the AFV, to follow the determined 14 path using dead reckoning or inertial measurement where readings from sensors can give an indication of movement of the AFV. Reading from sensors can include sensors detecting movement of the wheels of the AFV to indicate how far it has travelled, accelerometer sensors detecting acceleration and speed attained by the AFV, and a compass type sensor may indicate its direction or heading. This is shown by the small X marked as E in FIG. 17. In this way, the exact path followed by the guide element will be traversed without the use of a guidance system with a pre-provided map showing pathways that can be followed, and also preferably without the use of an obstacle detection system. This may be particularly useful where, for example the AFV 1000 is following a guide element such as a key fob or mobile phone on a tradesperson around a construction site, where a large number of obstacles may be present, and collision with these obstacles may present a safety hazard. Another example may be where the AFV 1000 is following a person holding a guide element through a series of passages between beach towels on a beach.

In determining 14 a path from the mapped location of the guide element, the controller 1500 may allocate 16 a path width (shown in FIG. 17 as width W) that extends transversely to either side of the mapped path to generate a path surface area over which the AFV can be steered. The controller 1500 will then control 18 the drive system to cause the AFV 1000 to follow the determined path, while staying within the bounds of the allocated 16 path surface area.

The controller 1500 will further receive 18 sensor signals from the accelerometer 1512, wheel speed sensor 1514, compass 1516 and any other relevant sensors 1518 in order to determine 20 the distance and heading that the AFV has travelled. This may be carried out through the known processes of inertial navigation. The updated location of the AFV will be mapped 22 with reference to the determined 14 path of the guide element.

The controller will then receive 12 an updated location signal from the wireless locating 1400, to follow the same cycle.

It is further envisaged that, while the controller 1500 is tracking movement of the guide element 3000 at frequent regular intervals or continuously, the controller may calculate the speed of the guide element 3000, regardless of the direction of movement of the guide element. The controller 1500 may further control the speed of the AFV 1000 in order to match the speed of the guide element 3000. This would be useful, for example where the guide element has turned a corner and is moving in a direction that may be transverse to the current direction of the AFV. In this way, the AFV may be kept at the constant distance from the guide element, irrespective of the direction in which the guide element is travelling.

### Interpretation

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular embodiments only and is not intended to be limiting of the invention. As used herein, the singular articles “a”, “an” and “the” are intended to include the plural forms as well, unless the context clearly indicates otherwise and thus are used herein to refer to one or to more than one (i.e. to “at least one”) of the grammatical object of the article. By way of example, the phrase “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

The term “real-time” for example “displaying real-time data,” refers to the display of the data without intentional delay, given the processing limitations of the system and the time required to accurately measure the data.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In accordance with:

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database:

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

It will be appreciated that the methods/apparatus/devices/systems described/illustrated above at least substantially provide an autonomous follower vehicle.

The autonomous follower vehicle described herein, and/or shown in the drawings, are presented by way of example only and are not limiting as to the scope of the invention. unless otherwise specifically stated, individual aspects and components of the autonomous follower vehicle may be modified, or may have been substituted therefore known equivalents, or as yet unknown substitutes such as may be developed in the future or such as may be found to be acceptable substitutes in the future. The autonomous follower vehicle may also be modified for a variety of applications while remaining within the scope and spirit of the claimed invention, since the range of potential applications is great, and since it is intended that the present invention be adaptable to many such variations.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Combinations of Features in Embodiments

Different features are described in different embodiments in this specification, however it is envisaged that any features shown in any embodiment described may be used with any other features in any other embodiment in any combination, unless this is not logically possible.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Chronological Order

For the purpose of this specification, where method steps are described in sequence, the sequence does not necessarily mean that the steps are to be carried out in chronological order in that sequence, unless there is no other logical manner of interpreting the sequence.

### Markush Groups

In addition, where features or aspects of the invention are described in terms of Markush groups, those skilled in the art will recognise that the invention is also thereby described in terms of any individual member or subgroup of members of the Markush group.

### INDUSTRIAL APPLICABILITY

It is apparent from the above, that the arrangements described are applicable to the construction and recreation industries.

1. An autonomous follower vehicle (“AFV”) for following a guide element, the autonomous follower vehicle including:
a. a power source;
b. a prime mover;
c. a drive system configured for driving and steering the AFV;
d. a wireless locating system configured for locating a position of a guide element;
e. a control system configured for:
i. wirelessly determining the location of the guide element using the wireless locating system;
ii. mapping the determined location of the guide element over time as a path; and
iii. controlling the drive system to follow the same path traversed by the guide element.

2. The AFV as claimed in claim 1, wherein the controller is configured for:
a. controlling the drive system to follow the path traversed by the guide element using inertial navigation.

3. The AFV as claimed in claim 1, wherein the controller is configured for:
a. plotting the location of the guide element at an absolute geographic location on an electronic map over time, with reference to the AFV.

4. The AFV as claimed in claim 1, wherein the controller is configured for:
a. testing whether the location of the guide element is within a predetermined range of the AFV; and
b. stopping movement of the AFV in the event that the location of the guide element is within a predetermined range of the AFV.

5. The AFV as claimed in claim 1, wherein the controller is configured for:
a. allocating a path width to the determined path; and
b. controlling the drive system to cause the AFV to follow the determined path while staying within the allocated width.

6. The AFV as claimed in claim 1, wherein the controller is configured for:
a. receiving a sensor signals indicative of speed and heading of the AFV;
b. determining a distance and heading that the AFV has travelled from the sensor signals; and
c. mapping an updated location of AFV relative to the determined path of the guide element.

7. The AFV as claimed in claim 1, wherein the controller is configured for:
a. calculating a speed of the guide element along the path;
b. calculating a speed of the AFV along the path;
c. comparing the calculated speed of the guide element along the path to the calculated speed and direction of movement of the AFV along the path; and
d. controlling the drive system to cause the AFV to match the speed of the guide element along the path.

8. The AFV as claimed in claim 1, wherein the AFV is configured for carrying a container.

9. The AFV as claimed in claim 8, wherein the container is a removable container.

10. The AFV as claimed in claim 1, wherein the controller is configured for:
a. controlling the drive system to keep the autonomous follower vehicle in the same position while the guide element is moving towards the autonomous follower vehicle.

11. The AFV as claimed in claim 1, wherein the AFV includes:
a. a chassis configured for being reconfigured between a
i. deployed configuration in which the chassis is capable of carrying a load, and a
ii. retracted configuration in which the chassis is reduced in size.

12. A method of controlling an autonomous follower vehicle (“AFV”), the AFV including a wireless locating system and a drive system, the method being carried out on an electronic device and including the steps of:
a. wirelessly determining the location of a guide element using a wireless locating system;
b. mapping the location of the guide element over time as a path; and
c. controlling the drive system to follow the path traversed by the guide element.

13. The method as claimed in claim 12, wherein the method comprises the step of:
a. plotting the location of the guide element at an absolute geographic location on an electronic map over time, with reference to the AFV.

14. The method as claimed in claim 12, wherein the method comprises the step of:
a. testing whether the location of the guide element is within a predetermined range of the AFV; and
b. stopping movement of the AFV in the event that the location of the guide element is within a predetermined range of the AFV.

15. The method as claimed in claim 12, wherein the method comprises the step of:
a. allocating a path width to the determined path; and
b. controlling the drive system to cause the AFV to follow the determined path while staying within an allocated width.

16. The method as claimed in claim 12, wherein the method comprises the step of:
a. receiving a sensor signals indicative of speed and heading of the AFV;
b. determining a distance and heading that the AFV has travelled from the sensor signals; and
c. mapping an updated location of AFV relative to the determined path of the guide element.

17. The method as claimed in claim 12, wherein the method comprises the step of:
a. calculating a speed of the guide element along the path;
b. calculating a speed of the AFV along the path;
c. comparing the calculated speed of the guide element along the path to the calculated speed and direction of movement of the AFV along the path; and
d. controlling the drive system to cause the AFV to match the speed of the guide element along the path.
